(19) United States
(12) Patent Application Publication
(10) Pub. No.: US 2021/0219499 A1
(43) Pub. Date: Jul. 22, 2021

(54) MULTI CHAMBER PLANT GROWTH DEVICE

(71) Applicant: JACOB HENSON, CINCINNATI, OH (US)

(72) Inventor: JACOB HENSON, CINCINNATI, OH (US)

(21) Appl. No.: 16/594,034

(22) Filed: Oct. 6, 2019

(51) Int. Cl. A01G 9/02; A01G 9/029

(52) U.S. Cl. CPC A01G 9/023; A01G 9/028; A01G 9/0295

(57) ABSTRACT

The invention is a plant growth chamber. Specifically, the plant growth chamber is multi-chambered and has the ability to grow multiple plants in several stages such that plant harvesting can occur every thirty to sixty days.

### FIELD OF THE INVENTION

The invention is a plant growth chamber. Specifically, the plant growth chamber is multi-chambered and has the ability to grow multiple plants in several stages such that plant harvesting can occur every thirty to sixty days.

### BACKGROUND OF THE INVENTION

Farming has existed, researchers believe, for 20,000 years or more. The very first time that a man and woman could grow vegetation based food was also the first time that they and their family could decide to reside in a particular locale longer than the period of wild game residence. More than any other invention, farming is the chief reason by which civilizations occurred and became established, most notably in Africa and later, in the Middle East.

As farming became more prevalent, civilizations sprung up. As it became more advanced, civilizations were able to persist, grow and advance. Farming not only benefitted its human recipients. It also enabled the farmers to domesticate and raise livestock for food and for work.

In modern times, farming is big business. It is digital, computerized and soon, fully automated. It is also local. While farming is big business, smaller farmers persist and work to innovate to farm for organic food, ornament, entertainment and medicinal purposes.

Farming at this level, especially where land for farming is sparse or non-existent, is difficult. This is true most often in cities, suburbs and other land limited locales. In such locales, the ability to farm for a desired purpose, and particularly where there are local, state or national restrictions therefor, is critical.

What is required therefore is a farming system that enables localized farming in a manner that adheres to existing laws and ordinances while also producing desirable crops in a regular, repeatable manner.

### SUMMARY OF THE INVENTION

Accordingly, the invention is a multi-chambered plant growing device, comprising a first chamber having a seedling section useful for growing plants from their seedling form; a second chamber having a vegetative section useful for obtaining substantial growth of the plants; a third chamber having a blooming section useful for the second stage of growth of the plants; and a fourth chamber having a drying section useful for pruning and optimizing the full growth of the plants.

In practice, at least two plants are growable in the seedling section. Ideally, two plants at a time can and will be grown in the seedling section. At least two plants are growable in the vegetative section. At least two plants are growable in the drying section. Herein, the plants grown in the multi-chambered plant growing device are cured in the drying section.

The multi-chambered plant growing device preferably comprises a ventilation system. The ventilation system comprises at least one fresh air intake, at least one exhaust vent, at least one drying active vent, at least one drying passive vent, at least one vegetative passive vent, and at least one vegetative active vent. In practice, the vegetative active vent adjoins the vegetative and blooming sections. The vegetative passive tent adjoins the vegetative and blooming sections. The drying active vent adjoins the blooming and seeding sections. The drying passive vent adjoins the blooming and seeding sections.

The multi-chambered plant growing device comprises six sides: a top side, a bottom side, and four adjoining wails. The preferred shape of the device is a rectangular cube though multiple other shapes are suitable so long as the first, second, third and fourth chambers exist therein.

In practice, the multi-chambered plant growing device produces at least two mature, harvestable plants every thirty days when each the first chamber, the second chamber, the third chamber and the fourth chamber are used and occupied with the plants. This harvestable rate comes about when each chamber is efficiently and maximally used.

As part of the ventilation system, it is an ideal feature thereof to continuously monitor air quality within the multi-chambered plant growing device. If air within the multi-chambered plant growing device falls outside of acceptable parameters, the ventilation system can be adjusted to improve air quality and therefore bring it back within acceptable parameters. Thus, the multi-chambered plant growing device preferably comprises an oxygen/carbon dioxide (O₂/CO₂) device that monitors levels thereof within the multi-chambered plant growing device.

The O₂/CO₂ device is preferably electronic and guided by intelligent algorithms that monitor air quality, actuate the vents, fans and other hardware of the ventilation system. Control of the air quality within the multi-chambered plant growing device can be done remotely by secondary device equipped with a connecting application (e.g., IPHONE®, IPAD®, ANDROID®, or similar computerized device).

### BRIEF DESCRIPTION OF THE FIGURES

The various exemplary embodiments of the present invention, which will become more apparent as the description proceeds, are described in the following detailed description in conjunction with the accompanying drawings, in which:

FIG. 1 is a perspective view of the multi-chambered plant growing device herein; and

FIG. 2 is a perspective view of the multi-chambered plant growing device showing a six stage growth process herein.

### DETAILED DESCRIPTION OF THE INVENTION

The invention herein is a multi-chambered plant growing device, comprising a first chamber having a seedling section useful for growing plants from their seedling form; a second chamber having a vegetative section useful for obtaining substantial growth of the plants; a third chamber having a blooming section useful for the second stage of growth of the plants; and a fourth chamber having a drying section useful for pruning and optimizing the full growth of the plants.

In practice, at least two plants are growable in the seedling section. Ideally, two plants at a time can and will be grown in the seedling section. At least two plants are growable in the vegetative section. At least two plants are growable in the drying section. Herein, the plants grown in the multi-chambered plant growing device are cured in the drying section.

The multi-chambered plant growing device preferably comprises a ventilation system. The ventilation system comprises at least one fresh air intake, at least one exhaust vent, at least one drying active vent, at least one drying passive vent, at least one vegetative passive vent, and at least one vegetative active vent. In practice, the vegetative active vent adjoins the vegetative and blooming sections. The vegetative passive tent adjoins the vegetative and blooming sections. The drying active vent adjoins the blooming and seeding sections. The drying passive vent adjoins the blooming and seeding sections.

The multi-chambered plant growing device comprises six sides: a top side, a bottom side, and four adjoining walls. The preferred shape of the device is a rectangular cube though multiple other shapes are suitable so long as the first, second, third and fourth chambers exist therein.

In practice, the multi-chambered plant growing device produces at least two mature, harvestable plants every thirty days when each the first chamber, the second chamber, the third chamber and the fourth chamber are used and occupied with the plants. This harvestable rate comes about when each chamber is efficiently and maximally used.

As part of the ventilation system, it is an ideal feature thereof to continuously monitor air quality within the multi-chambered plant growing device. If air within the multi-chambered plant growing device falls outside of acceptable parameters, the ventilation system can be adjusted to improve air quality and therefore bring it back within acceptable parameters. Thus, the multi-chambered plant growing device preferably comprises an oxygen/carbon dioxide (O₂/CO₂) device that monitors levels thereof within the multi-chambered plant growing device.

The O₂/CO₂ device is preferably electronic and guided by intelligent algorithms that monitor air quality, actuate the vents, fans and other hardware of the ventilation system. Control of the air quality within the multi-chambered plant growing device can be done remotely by secondary device equipped with a connecting application (e.g., IPHONE®, IPAD®, ANDROID®, or similar computerized device).

The embodiments herein provide for a both a four stage growth process and a six stage growth process. Details of each are provided in EXAMPLES I and II, respectively. Also provided are examples of the growth cycle for each growth process. The four and six stage growth processes of EXAMPLES I and II provide for small, medium and large tents of the types and kinds described in detail herein.

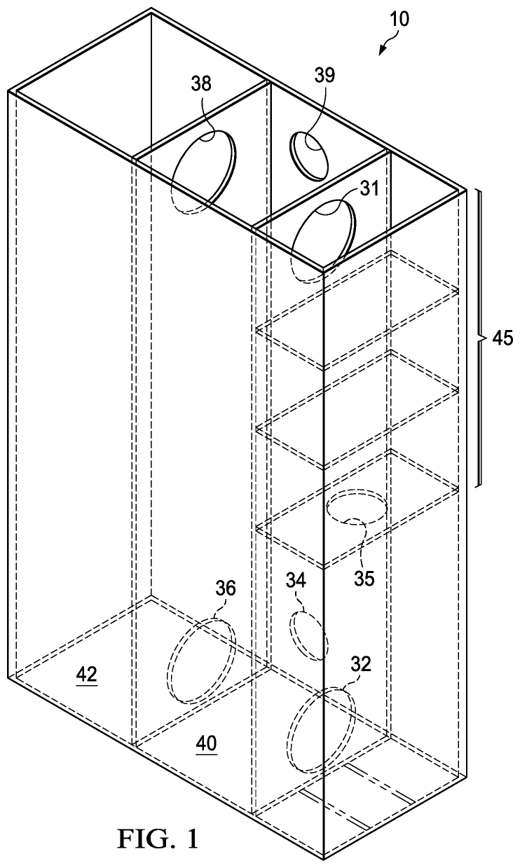

FIG. 1 is a perspective view of the multi-chambered plant growing device 10 (i.e., tent 10) herein. Tent 10 provides a flexible structure that is light weight and movable. It is created to be readily movable by its owner. Tent 10 can be made to stand on its own through the use of metal, plastic or wood rods fitted into its corners, similar to the kind of rods used in conventional tents.

FIG. 1 provides tent 10 having four main sections. Also provided is ventilation system 30 with its component vents. Vent 31 provides a seed/clone/drying active vent which comprises, preferably, a plastic duct fan (not shown). The fan blows air onto one or more blooming plants positioned within blooming section 40. Vent 32 provides a seed/clone/drying passive vent that snakes into seed/clone/drying section 42. Vent 34 provides a fresh air intake from the rear of tent 10 into blooming section 40. Preferably, vent 34 also provides an intake fan (not shown) that draws air into blooming section 40.

Vent 36, shown in FIG. 1, provides a vegetative vent that snakes into vegetative section 42 which eliminates light leakage of air and fumes between blooming section 40 and vegetative section 42. Vent 38 provides a vegetative active vent with air travelling therethrough vegetative section 42 to blooming section 40. Vent 39 is an exhaust vent preferably placed on the top of tent 10. Vent 39 may comprise a fan by which air within tent 10 in blooming section 40 is expelled.

The objective of vents 31, 32, 34, 35, 36, 38 and 39 provide ventilation system 30. Ventilation system 30 allows the flow of air into and out of tent 10. Such air flow is useful and necessary for the proper growth of plants within tent 10 at all stages of a plant's development. As important as it is for air to flow through tent 10, it is equally important to dispense with noxious fumes created by growing plant life within tent 10. For certain kinds of plants, this is important especially when tent 10 is used in enclosed spaces or smaller spaces.

Ventilation system 30 can be passive. By the term “passive” it is meant herein that a vent so described does not have a mechanical means by which to operate, i.e., a fan attached to the vent. Ventilation system 30 can be partially, substantially or fully “active”. By the term “active” it is meant herein that one or more vents herein has a fan installed therein to either draw or expel air into or out of tent 10.

As discussed hereinabove, FIG. 1 provides a perspective view of the multi-chambered plant growing device 10 (i.e., tent 10) showing a four stage growth process herein. Tent 10 provides four main sections: a blooming section, a vegetative section, a seeding or cloning section and a drying section. Also provided is a ventilation system 20 built substantially into tent 10 as disclosed hereinabove. Tent 10 herein provides for the full process of seeding to curing to produce matures plants in a four week cycle.

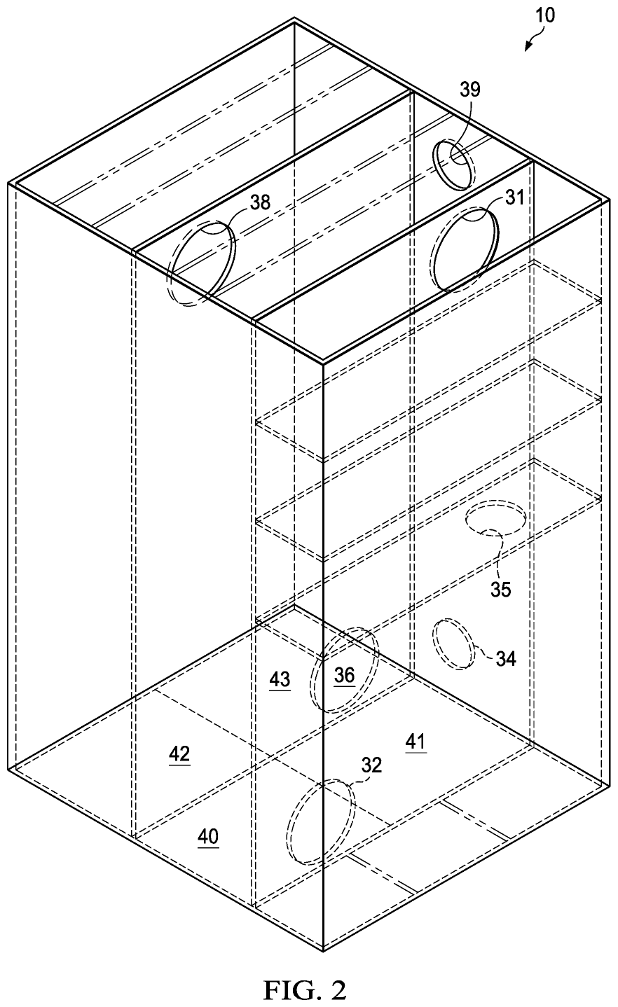

FIG. 2 is a perspective view of the multi-chambered plant growing device 10 (i.e., tent 10) showing a six stage growth process herein. Tent 10 provides four main sections: a blooming section, a vegetative section, a seeding or cloning section and a drying section. Also provided is a ventilation system 20 built substantially into tent 10 as disclosed hereinabove. Tent 10 herein provides for the full process of seeding to curing to produce matures plants in a four week cycle. Tent 10 of FIG. 2 provides for twice the capacity as that of tent 10 of FIG. 1.

Tent 10 of FIG. 2 provides, essentially, double occupancy over that of tent 10 in FIG. 1. For example, there are two vegetative sections 42 and 43, and two blooming sections 40 and 41. In practice, both vegetative sections 42 and 43 and blooming sections 40 and 41 have plants in either suitable states of vegetation or blooming thereby making maximum use of tent 10's increased capacity.

Also provided is ventilation system 30 with its component vents. Vent 31 provides a seed/clone/drying active vent which comprises, preferably, a plastic duct fan (not shown). The fan blows air onto one or more blooming plants positioned within blooming section 40. Vent 32 provides a seed/clone/drying passive vent that snakes into seed/clone/drying section 42. Vent 34 provides a fresh air intake from the rear of tent 10 into blooming section 40. Preferably, vent 34 also provides an intake fan (not shown) that draws air into blooming section 40.

A particularly useful plant for multi-chambered plant growing device 10 is the Cannabis plant. The entire Cannabis growth cycle is possible within device 10. Advantageously, multiple cycles of Cannabis growth may appear inside of device 10 within all of its chambers from initial planting to drying.

An example of a typical Cannabis growth cycle is as follows:
Three to Four weeks seeding or 2 weeks cloning under 18 hours of light 6 hours dark or up to 24 hours light. The more light at the beginning of a plants life cycle will result in more stretch from the stems in this stage of the plants life cycle;
Six to Eight weeks in the vegetative state under 18 hours light and 6 hours dark. With only 6 hours of Sleep it is important to have Infra-Red in your light spectrum to help your plants go to Sleep and Wake up. During this stage you will do the most invasive pruning and your plants will do the most “stretch” growth so it is important to give your plant adequate lighting while giving your plants sufficient time for sleep for healing girth growth;
Six to Eight weeks in the blooming state under 12 hours light and 12 hours dark. In this stage your plants will do the most “Swelling” growth so it is important to give your plants as much sleeping time as possible without Starving your plant for light as well. During this stage the plants are growing trichomes and this is where the potency of your plants come from;
Two to Four weeks drying. During this stage it is important to pay attention to your clippings as they are rapidly dried until the stems start to snap under slight pressure but not overly dry as to where your product crumbles; and
Zero to Twelve weeks curing. During this stage moisture is slowly extracted from your clippings without over drying while preventing mold growth. During this stage is when your plants robust flavors and smells come from.

The total time of development from seed is between seventeen to thirty-six weeks. The total time to clone the plant is from sixteen to thirty-four weeks. One important benefit achieved by multi-chambered plant growing device 10 is to stay within legal guidelines regarding personal use and cultivation of a female cannabis plant with no more than 2 blooming plants growing at any given time. Multi-chambered plant growing device 10 also facilitates the growth of determinant fruits and vegetables such as Green Beans or Roma Tomatoes and plants that die after they flower and fruit.

### EXAMPLE I—FOUR STAGE GROWTH PROCESS

### Small-Medium-Large Tents

### 1. Small Tent

Outside dimensions—4 ft. 6 in. wide by 2 ft. deep by 6 ft. 6 in. tall. 58.5 ft³.
Blooming section—2 ft.×2 ft.×6 ft. 6 in
Vegetative section—1 ft. 6 in.×2 ft.×6 ft. 6 in.
Seeding/cloning section—1 ft.×2 ft.×3 ft. 3 in.
Drying section—1 ft.×2 ft.×3 ft. 3 in.
3×300 W ADSS LED's

### 2. Medium Tent

Outside dimensions—5 ft. wide by 2 ft. 6 in. deep by 6 ft. 6 in. tall. 81.25 ft³.
Blooming section—2 ft. 6 in.×2 ft. 6 in.×6 ft. 6 in.
Vegetative section—1 ft. 6 in.×2 ft. 6 in.×6 ft. 6 in.
Seeding/cloning section—1 ft.×2 ft. 6 in.×3 ft. 3 in.
Drying section—1 ft.×2 ft. 6 in.×3 ft. 3 in.
3×300 W ADSS LED's

### 3. Large Tent

Outside dimensions—5 ft. 6 in. wide by 3 ft. deep by 6 ft. 6 in. tall. 107.25 ft³.
Blooming section—3 ft.×3 ft.×6 ft. 6 in.
Vegetative section—1 ft. 6 in.×3 ft.×6 ft. 6 in.
Seeding/cloning section—1 ft.×3 ft.×3 ft. 3 in.
Drying section—1 ft.×3 ft.×3 ft. 3 in.
2×300 W+1×600 W ADSS LED's.

### Growth Cycle

4. Normal Growth—Harvest 1 new plant every 6-8 weeks.
3-4 Weeks seeding/2 weeks cloning. 18/6-24/0 hours lighting.
6-8 Weeks vegetative growth. 16/8 hours lighting.
6-8 Weeks blooming growth. 12/12 hours lighting. Start topping as top matures.
2-4 Weeks drying.
0-12 Weeks curing.
Total time 17-36 weeks from seed.
Total time 16-34 weeks from clone.
   5. Auto Flowering or Stunted Growth—Harvest 1 new plant every 3-4 weeks. *Recommended tent for Auto Flowering.*
3-4 Weeks Seeding/2 Weeks Cloning. 18/6-24/0 hours lighting.
3-4 Weeks vegetative growth. 16/8 hours lighting. Lighting change to 12/12 half way through.
3-4 Weeks blooming growth. 12/12 hours lighting.
2-4 Weeks drying.
0-12 Weeks curing.
Total time 11-28 weeks from seed.
Total time 10-26 weeks from clone.

### EXAMPLE II—SIX STAGE GROWTH PROCESS

### Small-Medium-Large Tents

1. Small Tent—Outside dimensions—4 ft. 6 in. wide by 4 ft. deep by 6 ft. 6 in. tall. 117 ft³.
Blooming section—2 ft.×4 ft.×6 ft. 6 in.
Vegetative section—1 ft. 6 in.×4 ft.×6 ft. 6 in.
Seeding/cloning section—1 ft.×4 ft.×3 ft. 3 in.
Drying section—1 ft.×4 ft.×3 ft. 3 in.
5×300 W ADSS LED lights
   2. Medium Tent—Outside dimensions—5 ft. wide by 5 ft. deep by 6 ft. 6 in. tall.—162.5 ft³.
Blooming section—2 ft. 6 in.×5 ft.×6 ft. 6 in.—81.25 ft³.
Vegetative section—1 ft. 6 in.×5 ft.×6 ft. 6 in.—48.75 ft³.
Seeding/cloning section—1 ft.×5 ft.×3 ft. 3 in.—16.25 ft³.
Drying section—1 ft.×5 ft.×3 ft. 3 in.—16.25 ft³.
5×300 W ADSS LED's
   3. Large Tent—Outside dimensions—5 ft. 6 in. wide by 6 ft. deep by 6 ft. 6 in. tall.—214.5 ft³.
Blooming section—3 ft.×6 ft.×6 ft. 6 in.—117 ft³.
Vegetative section—1 ft. 6 in.×6 ft.×6 ft. 6 in.—58.5 ft³.
Seeding/cloning section—1 ft.×6 ft.×3 ft. 3 in.—19.5 ft³.
Drying section—1 ft.×6 ft.×3 ft. 3 in.—19.5 ft.³.
3×300 W+2×600 W ADSS LED's.

### Growth Cycle

Normal Growth—Harvest 1 new plant every 3-4 weeks.
3-4 Weeks seeding/2 weeks cloning 18/6 hours lighting or 24/0 hours lighting.
3-4 Weeks first vegetative growth. 18/6 hours lighting.
3-4 Weeks second vegetative growth. 18/6 hours lighting.
3-4 Weeks first blooming growth. 12/12 hours lighting.
3-4 Weeks second blooming growth. 12/12 hours lighting. Start topping as the top matures.
2-4 Weeks drying.
0-12 Weeks curing.
Total time 17-36 weeks from seed.
Total time 16-34 weeks from clone.
   Auto Flowering or Stunted Growth—Harvest 1 new plant every 1.5-3 weeks. *Not recommended tent for Auto Flowering or Stunted Growth.*
3 Weeks seeding/2 Weeks cloning. 18/6 hours lighting or 24/0 hours lighting.
1.5-3 Weeks first vegetative growth. 18/6 hours lighting.
1.5-3 Weeks second vegetative growth. 12/12 hours lighting.
1.5-3 Weeks first blooming growth. 12/12 hours lighting.
1.5-3 Weeks second blooming growth. 12/12 hours lighting.
2-3 Weeks drying.
0-12 Weeks curing.
Total lime 11-28 Weeks from seed.
Total time 10-26 Weeks from clone.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A multi-chambered plant growing device, comprising:
a. A first chamber having a seedling section useful for growing plants from their seedling form;
b. A second chamber having a vegetative section useful for obtaining substantial growth of said plants;
c. A third chamber having a blooming section useful for the second stage of growth of said plants; and
d. A fourth chamber having a drying section useful for pruning and optimizing the full growth of said plants.

2. The multi-chambered plant growing device of claim 1 wherein at least two plants are growable in said seedling section.

3. The multi-chambered plant growing device of claim 1 wherein at least two plants are growable in said vegetative section.

4. The multi-chambered plant growing device of claim 1 wherein at least two plants are growable in said drying section.

5. The multi-chambered plant growing device of claim 1 wherein said plants are cured in said drying section.

6. The multi-chambered plant growing device of claim 1 further comprising a ventilation system.

7. The multi-chambered plant growing device of claim 6 wherein said ventilation system comprises at least one fresh air intake, at least one exhaust vent, at least one drying active vent, at least one drying passive vent, at least one vegetative passive vent, and at least one vegetative active vent.

8. The multi-chambered plant growing device of claim 1 wherein said device produces at least two mature, harvestable plants every thirty days when each said first chamber, said second chamber, said third chamber and said fourth chamber are used and occupied with said plants.

9. The multi-chambered plant growing device of claim 1 wherein said device comprises an O₂/CO₂ device that monitors levels of O₂/CO₂ within said multi-chambered plant growing device.

10. The multi-chambered plant growing device of claim 9 wherein said O₂/CO₂ device is electronic.
